(19) United States
(12) Patent Application Publication
(10) Pub. No.: US 2015/0103539 A1
(43) Pub. Date: Apr. 16, 2015

(54) LIGHT SOURCE MODULE AND METHOD OF MANUFACTURING THE SAME

(71) Applicant: SAMSUNG ELECTRONICS CO., LTD., Suwon-si (KR)

(72) Inventor: Yeon Woo LEE, Seoul (KR)

(21) Appl. No.: 14/297,276

(22) Filed: Jun. 5, 2014

(30) Foreign Application Priority Data
Oct. 11, 2013 (KR) 10-2013-0121376

(51) Int. Cl. F21V 21/00; F21V 29/00; F16M 13/02

(52) U.S. Cl. CPC F21V 21/00; F16M 13/02; F21V 29/004
USPC 362/382; 29/525.08

(57) ABSTRACT

A light source module is provided and includes a bracket having one or more fastening regions including a fastener. A heat radiator includes a fastening groove to which the fastener is fastened. A light source is disposed on the heat radiating part. The heat radiator may be detachably fastened to the one or more fastening regions when the fastening groove and the fastener are fastened to one another.

### CROSS-REFERENCE TO RELATED APPLICATION

This application claims the benefit of Korean Patent Application No. 10-2013-0121376 filed on Oct. 11, 2013, with the Korean Intellectual Property Office, the disclosure of which is incorporated herein by reference in its entirety.

### BACKGROUND

The present disclosure relates to a light source module and a method of manufacturing the same.

In general, as a light source used in a vehicle lamp, a module having a plurality of light emitting diodes (LEDs) arranged according to a structural design has been widely used. In such a module, arrangements of LEDs are determined depending on diverse designs of lamps appearing in vehicle models.

A module used in vehicle lamps may have a structure in which a back cover, a heat sink, and a substrate are stacked on and fixed to one another by compressing the heat sink dissipating heat and the substrate supplying electricity to a plurality of LEDs on the back cover, a plastic injection molded product, through a staking process. The back cover and the heat sink by which the LEDs are supported may have various shapes and sizes for different vehicle models, such that the plurality of LEDs are disposed in predetermined positions in accordance with lamp designs.

In order to perform the staking process, it is necessary to use a staking jig and a staking machine corresponding to a specific structure of a module, whereby manufacturing costs increase and manufacturing processes are complicated.

### SUMMARY

An aspect of the present disclosure may provide a light source module and a method of manufacturing the same that does not need a staking jig and a staking machine by removing a staking process.

According to an aspect of the present disclosure, a light source module is provided. The light source module includes a bracket part having one or more fastening regions including a fastening member. A heat radiating part includes a fastening groove to which the fastening member is fastened, and is detachably fastened to the one or more fastening regions when the fastening groove and the fastening member are fastened to one another. A light source part is disposed on the heat radiating part.

The bracket part may include a first bracket having the fastening member and a second bracket bent at one end of the first bracket and extending perpendicularly therefrom. The fastening regions may each include one surface of the first bracket on which the fastening member is provided and one surface of the second bracket perpendicular to the surface of the first bracket.

The second bracket may include an auxiliary fastening member.

The bracket part may have a through hole in a portion thereof where the first and second brackets are interconnected. The through hole allows the heat radiating part to partially pass therethrough.

The bracket part may further include one or more connecting brackets connecting the fastening regions to one another. The connecting brackets and the fastening regions may be alternately interconnected to form an extended step structure.

The heat radiating part may include: a heat radiating plate having the fastening groove and disposed on the first bracket. A first extension plate extends from one end of the heat radiating plate in a direction perpendicular thereto to be in contact with the surface of the second bracket.

The first extension plate may include an auxiliary fastening groove to which the auxiliary fastening member of the second bracket is fastened.

The heat radiating part may further include a second extension plate extending perpendicularly from the other end of the heat radiating plate in a direction opposite to that of the first extension plate.

The light source part may include: a substrate; and a light emitting device mounted on the substrate.

According to another aspect of the present disclosure, a method of manufacturing a light source module is provided. The method includes preparing a bracket part having one or more fastening regions defined by a first bracket on which a fastening member is provided and a second bracket bent at one end of the first bracket and extending perpendicularly therefrom. A heat radiating part is prepared and includes a heat radiating plate having a fastening groove to which the fastening member is fastened, a first extension plate extending from one end of the heat radiating plate, and a second extension plate extending from the other end of the heat radiating plate. The fastening member is fastened to the fastening groove in a state in which the first extension plate passes through the second bracket and protrudes in a direction opposite to that of the first bracket. The bracket part is fitted into the heat radiating part such that the heat radiating plate is fixedly placed on the first bracket. The first extension plate is bent, protruding externally after passing through a through hole formed in a portion of the bracket part where the first and second brackets are interconnected, to be extended along the second bracket.

The bracket part may further include one or more connecting brackets connecting the fastening regions to one another, and the connecting brackets and the fastening regions may be alternately interconnected to form an extended step structure.

The method may further include bending the second extension plate to be extended in a direction opposite to that of the first extension plate with respect to the heat radiating plate before fitting the bracket part into the heat radiating part.

The bending of the second extension plate may include bending a portion of the second extension plate to be parallel to the heat radiating plate.

The bending of the first extension plate may include fastening an auxiliary fastening member provided on the second bracket to the first extension plate in contact with one surface of the second bracket.

The method may further include mounting a light source part on the heat radiating plate.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic perspective view illustrating a light source module according to an exemplary embodiment of the present disclosure;

FIG. 2 is a schematic perspective view illustrating the rear of the light source module of FIG. 1;

FIG. 3 is a schematic perspective view illustrating a fastening region in the light source module of FIG. 1;

FIG. 4 is an exploded perspective view of FIG. 3;

FIG. 5 is a schematic perspective view illustrating the rear of FIG. 3;

FIGS. 6A through 10 are schematic perspective views illustrating a method of manufacturing a light source module according to an exemplary embodiment of the present disclosure;

FIG. 11 is a schematic perspective view illustrating an example of a light source module according to an exemplary embodiment of the present disclosure applied to a lighting device; and

FIG. 12 is a schematic perspective view illustrating other examples of a light source module according to an exemplary embodiment of the present disclosure applied to lighting devices.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

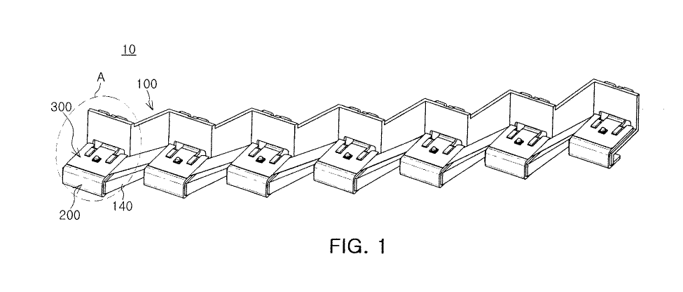

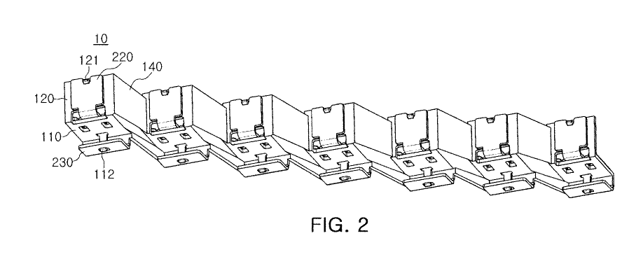

A light source module according to an exemplary embodiment of the present disclosure will be described with reference to FIGS. 1 and 2. FIG. 1 is a schematic perspective view illustrating a light source module according to an exemplary embodiment of the present disclosure, and FIG. 2 is a schematic perspective view illustrating the rear of the of the light source module of FIG. 1

With reference to FIGS. 1 and 2, a light source module according to an exemplary embodiment of the present disclosure may include a bracket part 100, a heat radiating part 200 and a light source part 300.

The bracket part 100 may have at least one fastening region A, and may be formed by injection molding an insulating resin. For example, the insulating resin may include polycarbonate (PC), polymethyl methacrylate (PMMA), and the like.

As illustrated in FIGS. 1 and 2, the fastening regions A may be connected to one another through connecting brackets 140. The connecting brackets 140 and the fastening regions A may be alternately interconnected to form an extended step structure. Therefore, the fastening regions A may be provided in plural, and may be arranged at different levels, not in a line.

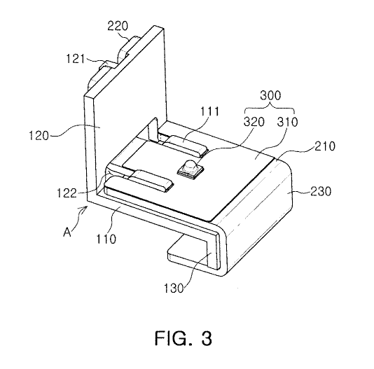

FIGS. 3 through 5 schematically illustrate parts of the bracket constituting the fastening region A.

The bracket part 100 may include a first bracket 110 (FIG. 2) provided with a fastening member and a second bracket 120 bent at one end of the first bracket 110 and extending perpendicularly therefrom. Therefore, the bracket part 100 may have an “L”-like shape.

In addition, the bracket part 100 may further include a third bracket 130 (FIG. 3) bent at the other end of the first bracket 110 and extending perpendicularly therefrom in a direction opposite to that of the second bracket 120. Here, the third bracket 130 is optional, and may be omitted unlike the illustrated bracket part.

For example, the fastening region A may include a first surface of the first bracket 110 on which the fastening member 111 is provided and a first surface of the second bracket 120 perpendicular to the first surface of the first bracket 110. In a case in which the third bracket 130 is provided as illustrated, the fastening region A may further include a first surface of the third bracket 130. The fastening region A may have the heat radiating part 200 fixedly placed thereon.

In the present embodiment, the second and third brackets 120 and 130 are bent and extend perpendicularly from the first bracket 110 by way of example, but are not limited thereto. For example, the second and third brackets 120 and 130 may be slantly bent at a certain angle of inclination.

The bracket part 100 may include a through hole 122 in a portion thereof where the first and second brackets 110 and 120 are interconnected. The through hole 122 may allow the heat radiating part 200 to partially pass therethrough.

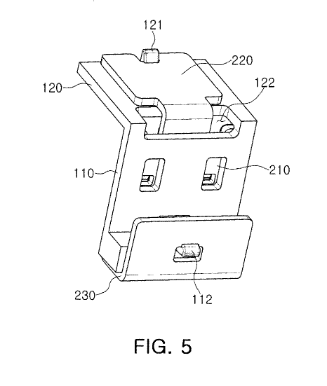

The fastening member 111 may be provided on the first bracket 110. The fastening member 111 may protrude upwardly from the first surface of the first bracket 110, and may include, for example, a guide boss. The first bracket 110 may further include a hook 112 (FIG. 5) protruding from a second surface thereof opposing the first surface thereof. Here, the hook 112 may be optional.

The second bracket 120 may include an auxiliary fastening member 121. The auxiliary fastening member 121 may protrude from the first surface of the second bracket 120 or from a second surface of the second bracket 120 opposing the first surface thereof, and may include, for example, a hook. In the present embodiment, the auxiliary fastening member 121 protrudes from the second surface of the second bracket 120 opposing the first surface thereof facing the first bracket 110 by way of example, but is not limited thereto. Alternatively, the auxiliary fastening member 121 may protrude from the first surface of the second bracket 120.

The heat radiating part 200 may be detachably fastened to the fastening region A of the bracket part 100. The heat radiating part 200 may have the light source part 300 installed thereon and support the light source part 300, while serving as a heat sink outwardly dissipating heat generated in the light source part 300. Therefore, the heat radiating part 200 may be made of a material having high heat conductivity, for example, a metallic material such as aluminum (Al).

The heat radiating part 200 may include a heat radiating plate 210 having a fastening groove 211 to which the fastening member 111 is fastened and disposed on the first surface of the first bracket 110, and a first extension plate 220 extending from one end of the heat radiating plate 210 in a direction perpendicular thereto to be in contact with the first or second surface of the second bracket 120.

As illustrated, the first extension plate 220 may pass through the through hole 122 formed in the portion of the bracket part 100 where the first 110 and second brackets 120 are interconnected, such that it can be in contact with the second surface of the second bracket 120. This structure directly exposes the first extension plate 220 to the outside of the second surface of the second bracket 120, thereby improving heat dissipation efficiency.

Alternatively, the first extension plate 220 may be disposed to be in contact with the first surface of the second bracket 120. In this case, the first extension plate 220 does not pass through the through hole 122, and the through hole 122 may serve as a path for air flow. Therefore, heat dissipation may be implemented by natural cooling.

In addition, the heat radiating part 200 may further include a second extension plate 230 extending perpendicularly from the other end of the heat radiating plate 210 in a direction opposite to that of the first extension plate 220. The second extension plate 230 is optional, and may be omitted unlike the illustrated heat radiating part.

Therefore, the heat radiating part 200 may be overall shaped like the bracket part 100, such that it may be fastened to the bracket part 100 to provide a surface contact structure.

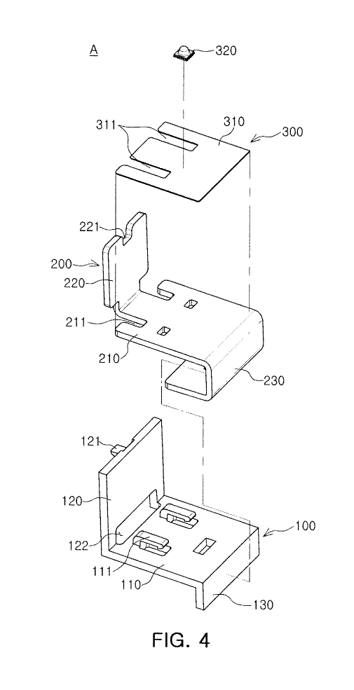

Like the heat radiating part 200 having the fastening groove 211 (FIG. 4) to which the fastening member 111 of the bracket part 100 is fastened, the first extension plate 220 may have an auxiliary fastening groove 221 to which the auxiliary fastening member 121 of the second bracket 120 is fastened.

When the heat radiating part 200 is fastened to the bracket part 100, the fastening groove 211 and the auxiliary fastening groove 221 are press-fitted to the fastening member 111 and the auxiliary fastening member 121, respectively, thereby generating fixing force and preventing the bracket part 100 and the heat radiating part 200 from being separated from one another. When the fastening member 111 is fastened to the fastening groove 211 and the auxiliary fastening member 121 is fastened to the auxiliary fastening groove 221, the fastening region A of the bracket part 100 and the heat radiating part 200 may be detachably fastened to one another.

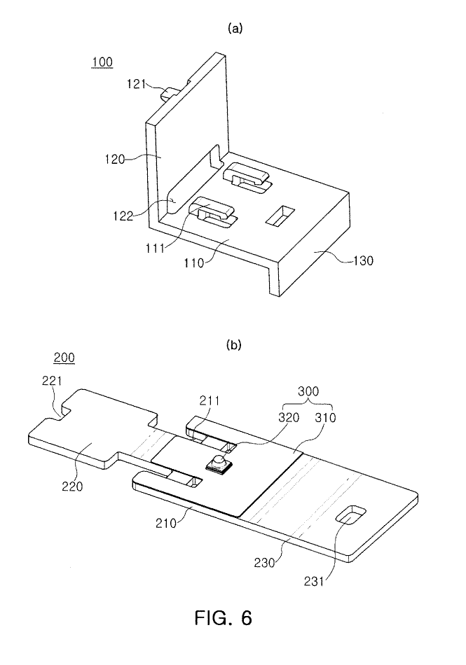

Meanwhile, in a case in which the heat radiating part 200 includes the second extension plate 230 as illustrated, the second extension plate 230 may have an auxiliary fastening hole 231 (FIG. 6). In this case, the hook 112 protruding from the second surface of the first bracket 110 opposing the first surface thereof may be fixedly inserted into the auxiliary fastening hole 231 formed in the second extension plate 230. Therefore, the heat radiating part 200 may be firmly fixed to the bracket part 100 due to the fastening groove 211 formed in the heat radiating plate 210 and the auxiliary fastening groove 221 and the auxiliary fastening hole 231 formed in the first and second extension plates 220 and 230, respectively.

The light source part 300 may be fixedly placed on the heat radiating part 200 and may emit light when power is supplied thereto. The light source part 300 may include a substrate 310 (FIG. 4) and a light emitting device 320 mounted on the substrate 310.

The substrate 310 may be a flexible printed circuit board (FPCB) that can be easily bent and deformed to provide various shapes. In addition, an FR4-type PCB may be used. The substrate 310 may also be made of an organic resin material containing epoxy, triazine, silicon, polyimide, or the like, and other organic resin materials, or may be made of a ceramic material such as a silicon nitride, AlN, Al₂O₃, or the like, or a metal and a metallic compound. For example, the substrate 310 may be a metal-core printed circuit board (MCPCB), a metal copper clad laminate (MCCL), or the like.

The light emitting device 320 may be mounted on the substrate 310 to be electrically connected thereto. Any photoelectric device may be used as the light emitting device 320 so long as it can emit light having a predetermined wavelength when power is applied thereto. As a representative light emitting device, a semiconductor light emitting diode (LED) in which semiconductor layers are epitaxially grown on a growth substrate may be used. The light emitting device 320 may emit blue light, green light or red light depending on a material contained therein, and may also emit white light.

For example, the light emitting device 320 may have a stacked structure of n-type and p-type semiconductor layers with an active layer interposed therebetween, but is not limited thereto. In addition, the active layer may be formed of a nitride semiconductor layer including InₓAl_{y}Ga_{1-x-y}N (0≦x≦1, 0≦y≦1, 0≦x+y≦1) having a single-quantum-well (SQW) structure or a multi-quantum-well (MQW) structure.

The light emitting device 320 may be various LED chip structures or various forms of LED packages including the LED chips. In the present embodiment, the light emitting device 320 is illustrated as an LED package by way of example, but is not limited thereto.

As described above, the light source module 10 according to this embodiment may be formed in a structure in which the heat radiating part and the bracket part are detachably assembled, rather than an existing structure in which a back cover, a heat sink and a substrate are integrally fixed through a staking process, whereby the degree of freedom of design may be increased. That is, the light source module 10 may be manufactured by appropriately assembling the heat radiating part 200 having the light source part 300 mounted thereon in a structure of a device to which the light source module is applied.

In addition, even when a part of the plurality of light emitting devices 320 malfunctions, only a heat radiating part having the corresponding light emitting device mounted thereon may be detached and replaced, whereby maintenance and repair may be facilitated. Therefore, it is not necessary to discard the entire light source module and replace it with a new light source module, which has previously led to cost increases.

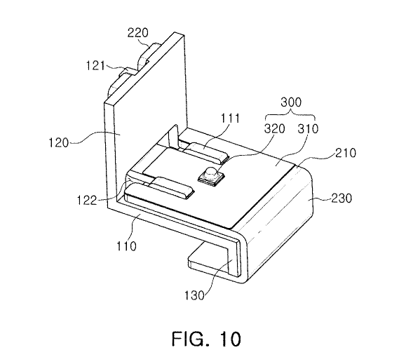

A method of manufacturing a light source module according to an exemplary embodiment of the present disclosure will be described with reference to FIGS. 6A through 10. Here, the method will be described with respect to a single fastening region since a description of a plurality of fastening regions constituting the light source module will be redundant.

FIGS. 6A through 10 are schematic perspective views illustrating a method of manufacturing a light source module according to an exemplary embodiment of the present disclosure.

As illustrated in FIG. 6A, the bracket part 100 having the fastening region A may be prepared, where the fastening region A is defined by the first bracket 110 on which the fastening member 111 is provided and the second bracket 120 bent at one end of the first bracket 110 and extending perpendicularly therefrom.

The fastening region A may be connected to another fastening region A through the connecting brackets 140. The fastening regions A and the connecting brackets 140 may be alternately interconnected to form an extended step structure (see FIG. 1).

The through hole 122 may be formed in a portion of the bracket part 100 where the first and second brackets 110 and 120 are interconnected, and the auxiliary fastening member 121 may be provided on the second bracket 120.

For example, the bracket part 100 may be integrally formed by injection molding a resin such as polycarbonate (PC), polymethyl methacrylate (PMMA), or the like.

As illustrated in FIG. 6B, the heat radiating part 200 including the heat radiating plate 210 having the fastening groove 211 to which the fastening member 111 is fastened, the first extension plate 220 extending from one end of the heat radiating plate 210 in a parallel manner, and the second extension plate 230 extending from the other end of the heat radiating plate 210 in a parallel manner may be prepared. The light source part 300 may be mounted on a top surface of the heat radiating plate 210.

The heat radiating part 200 including the heat radiating plate 210, the first extension plate 220, and the second extension plate 230 may be integrally formed by pressing a single metal plate. The heat radiating part 200 may be made of a metallic material such as aluminum, but is not limited thereto. The heat radiating plate 210 and the first and second extension plates 220 and 230 may have the fastening groove 211, the auxiliary fastening groove 221, and the auxiliary fastening hole 231 formed therein, respectively.

The heat radiating part 200 may be simultaneously prepared with the bracket part 100. The heat radiating part 200 and the bracket part 100 may each be prepared through separate processes.

The light source part 300 may include the substrate 310 and the light emitting device 320 mounted on the substrate 310. The substrate 310 may be an FPCB, and the light emitting device 320 may be a semiconductor LED.

In the present embodiment, the light source part 300 is mounted on the heat radiating part 200 as it is prepared, but the present disclosure is not limited thereto. For example, the light source part 300 may be mounted on the heat radiating part 200 during a final process.

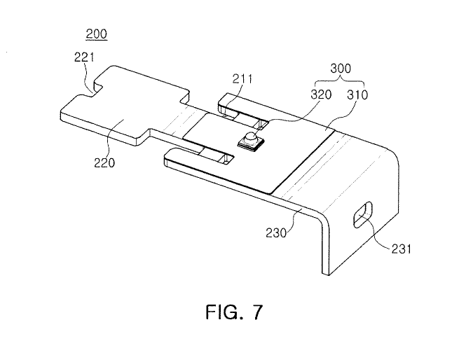

Next, as illustrated in FIG. 7, the second extension plate 230 may be bent to be extended in a direction perpendicular to the heat radiating plate 210. The second extension plate 230 may be bent using a general bending mold.

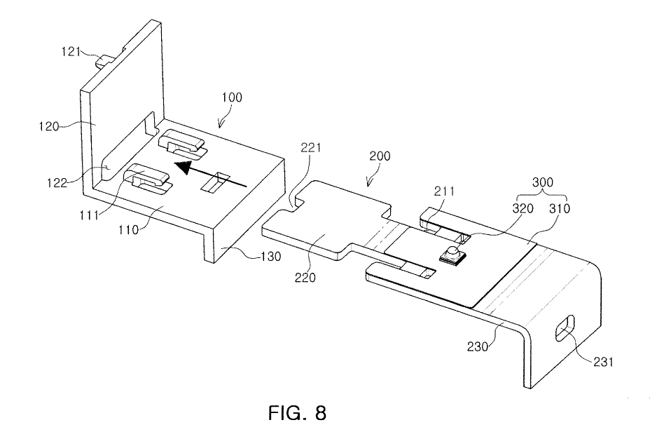

Then, as illustrated in FIG. 8, in a state in which the first extension plate 220 passes the second bracket 120 through the through hole 122 and protrude in a direction opposite to that of the first bracket 110, the heat radiating part 200 may be fitted into the bracket part 100 by fastening the fastening member 111 to the fastening groove 211 such that the heat radiating plate 210 is fixedly placed on the first bracket 110. In this manner, the heat radiating part 200 may be temporarily fastened to the fastening region A.

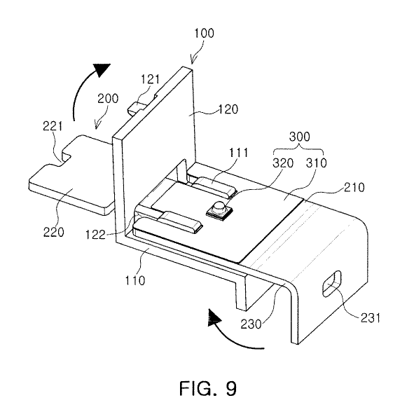

Next, as illustrated in FIG. 9, the first extension plate 220 protruding externally by passing through the through hole 122 formed in the portion of the bracket part 100 where the first and second brackets 110 and 120 are interconnected may be perpendicularly bent along the second bracket 120. Simultaneously, a portion of the second extension plate 230 may be bent to be parallel to the heat radiating plate 210.

When the first extension plate 220 and the second extension plate 230 are individually bent, the hook 112 provided on the first bracket 110 and the auxiliary fastening member 121 provided on the second bracket 120 may be fixedly inserted into the auxiliary fastening hole 231 provided in the second extension plate 230 and the auxiliary fastening groove 221 provided in the first extension plate 220, respectively.

Likewise, the first extension plate 220 and the second extension plate 230 may be bent using the bending mold.

As described above, the method of manufacturing a light source module according to the present embodiment is simplified by removing a staking process, resulting in improved productivity. In addition, a staking jig and a staking machine are rendered unnecessary, whereby investment costs may be reduced.

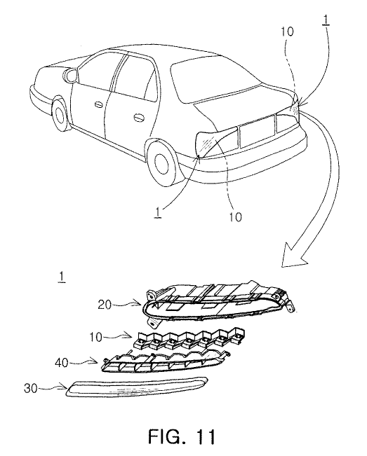

FIG. 11 is a schematic perspective view illustrating an example of a light source module according to an exemplary embodiment of the present disclosure applied to a lighting device. In the present embodiment, the lighting device is illustrated as a vehicle's rear lamp having the light source module installed therein by way of example.

As illustrated in FIG. 11, a lighting device 1 may include a housing 20 supporting the light source module 10 and a cover 30 covering the housing 20 to protect the light source module 10, and a reflector 40 may be disposed on the light source module 10.

The lighting device 1 may correspond to a shape of a corner of the vehicle and have an overall smoothly curved structure. Thus, the heat radiating part 200 may be assembled to the bracket part 100 so as to fit in the curved structure of the lighting device 1, thereby forming the light source module 10 having a step structure.

In the present embodiment, the bracket part 100 and the heat radiating part 200 assembled thereto are illustrated as having a linear-type step structure according to a design of the lighting device 1 byway of example; however, the structure of the light source module 10 may be varied according to a design of the lighting device 1, i.e., the rear lamp, and the number of heat radiating parts may change accordingly.

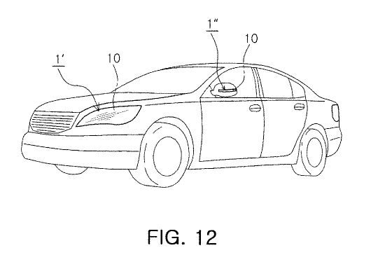

In the present embodiment, the lighting device 1 is illustrated as the rear lamp by way of example, but is not limited thereto. As illustrated in FIG. 12, a lighting device 1′ may be used as a vehicle's head lamp, and the light source module 10 may have a multi-step structure corresponding to a curved surface of the head lamp.

In addition, a lighting device 1″ may also be used as a turn signal lamp installed in a door mirror of a vehicle, and the light source module 10 may have a structure corresponding to a curved surface of the turn signal lamp.

As set forth above, according to exemplary embodiments of the present disclosure, a light source module and a method of manufacturing the same that does not need a staking jig and a staking machine by removing a staking process may be provided.

While exemplary embodiments have been shown and described above, it will be apparent to those skilled in the art that modifications and variations could be made without departing from the spirit and scope of the present disclosure as defined by the appended claims.

What is claimed is:

1. A light source module comprising:
a bracket having one or more fastening regions including a fastener;
a heat radiator having a fastening groove to which the fastener is fastened, and being detachably fastened to the one or more fastening regions when the fastening groove and the fastener are fastened to one another; and
a light source disposed on the heat radiator.

2. The light source module of claim 1, wherein:
the bracket includes a first bracket region having the fastener and a second bracket region bent at one end of the first bracket region and extending perpendicularly therefrom, and
the fastening regions each include one surface of the first bracket region on which the fastener is provided and one surface of the second bracket region perpendicular to the surface of the first bracket region.

3. The light source module of claim 2, wherein the second bracket region includes an auxiliary fastener.

4. The light source module of claim 2, wherein the bracket has a through hole in a portion thereof where the first and second bracket regions are interconnected, the through hole allowing the heat radiator to partially pass therethrough.

5. The light source module of claim 2, wherein the bracket further includes one or more connecting brackets for connecting the fastening regions to one another, and
the connecting brackets and the fastening regions are alternately interconnected to form an extended step structure.

6. The light source module of claim 3, wherein the heat radiator includes:
a heat radiating plate having the fastening groove and being disposed on the first bracket region; and
a first extension plate extending from one end of the heat radiator in a direction perpendicular thereto to be in contact with a surface of the second bracket region.

7. The light source module of claim 6, wherein the first extension plate includes:
an auxiliary fastening groove to which the auxiliary fastening member of the second bracket region is fastened.

8. The light source module of claim 6, wherein the heat radiator further includes:
a second extension plate extending perpendicularly from the other end of the heat radiating plate in a direction opposite to that of the first extension plate.

9. The light source module of claim 1, wherein the light source part includes:
a substrate; and
a light emitting device mounted on the substrate.

10. A method of manufacturing a light source module, the method comprising steps of:
preparing a bracket having one or more fastening regions defined by a first bracket region on which a fastener is provided and a second bracket region bent at one end of the first bracket and extending perpendicularly therefrom;
preparing a heat radiator including:
a heat radiating plate having a fastening groove to which the fastener is fastened,
a first extension plate extending from one end of the heat radiating plate, and
a second extension plate extending from the other end of the heat radiating plate;
fastening the fastener to the fastening groove in a state in which the first extension plate passes through the second bracket region and protrudes in a direction opposite to that of the first bracket region;
fitting the bracket into the heat radiator such that the heat radiating plate is fixedly placed on the first bracket region; and
bending the first extension plate, protruding externally after passing through a through hole formed in a portion of the bracket part where the first and second bracket regions are interconnected, to be extended along the second bracket region.

11. The method of claim 10, wherein the bracket further includes one or more connecting brackets connecting the fastening regions to one another, and
the connecting brackets and the fastening regions are alternately interconnected to form an extended step structure.

12. The method of claim 10, further comprising the step of:
bending the second extension plate to be extended in a direction opposite to that of the first extension plate with respect to the heat radiating plate before fitting the bracket into the heat radiator.

13. The method of claim 12, wherein the step of bending the second extension plate includes bending a portion of the second extension plate to be parallel to the heat radiating plate.

14. The method of claim 10, wherein the step of bending the first extension plate includes:
fastening an auxiliary fastener provided on the second bracket region to the first extension plate in contact with one surface of the second bracket region.

15. The method of claim 10, further comprising mounting a light source on the heat radiating plate.

16. A light source module comprising:
a bracket including:
a first bracket region having at least one fastener,
a second bracket region bent at one end of the first bracket region and extending perpendicularly therefrom, and
a third bracket region bent at the other end of the first bracket region and extending perpendicularly therefrom;
a heat radiator having a fastening groove to which the fastener is fastened, and being detachably fastened to the fastener when the fastening groove and the fastener are fastened to one another; and
a light source including a substrate and lighting emitting device mounted on the substrate, the light source disposed on the heat radiator.

17. The light source module of claim 16, wherein the second bracket region includes an auxiliary fastener.

18. The light source module of claim 17, wherein the heat radiator includes:
a heat radiating plate having the fastening groove and being disposed on the first bracket region; and a first extension plate extending from one end of the heat radiator in a direction perpendicular thereto to be in contact with a surface of the second bracket region.

19. The light source module of claim 18, wherein the heat radiator further includes:
a second extension plate extending perpendicularly from the other end of the heat radiating plate in a direction opposite to that of the first extension plate.

20. The light source module of claim 16, wherein:
the bracket includes a through hole in a portion thereof where the first and second bracket regions are interconnected, and
the through hole allows the first extension plate to partially pass therethrough.
